(19) United States
(12) Patent Application Publication
(10) Pub. No.: US 2012/0272320 A1
(43) Pub. Date: Oct. 25, 2012

(54) METHOD AND SYSTEM FOR PROVIDING MOBILE DEVICE SCANNING

(75) Inventors: Steven R. Rados, Danville, CA (US); Thomas Haynes, San Ramon, CA (US)

(73) Assignee: VERIZON PATENT AND LICENSING INC., Basking Ridge, NJ (US)

(21) Appl. No.: 13/093,206

(22) Filed: Apr. 25, 2011

(51) Int. Cl. G06F 21/00

(52) U.S. Cl. 726/24; 726/23

(57) ABSTRACT

An approach for providing mobile device scanning is described. A file stored within a mobile device is received. A scan of the received file is initiated to determine a status relating to presence of an unauthorized code or to execution of an unauthorized activity. A notification message is generated based on the scan, wherein the notification message specifies information relating to the determined status.

### BACKGROUND INFORMATION

Service providers are continually challenged to deliver value and convenience to consumers by providing compelling network services and advancing the underlying technologies. One area of interest has been the development of services and technologies for the detection and removal of malware—e.g., malicious programs designed to secretly access a user's computer without the user's knowledge or consent. Given the rapid advancement of mobile devices, such as smartphones and netbooks, these devices can execute sophisticated software applications. Consequently, these mobile devices and associated applications are becoming more vulnerable to malware attacks. However, conventional approaches in the development of malware detection and extraction have not considered the unique circumstances of mobile devices. For example, the loading and installation of software within mobile devices differ significantly from typical computers. Also, these devices are power constrained and processor constrained compared to those of typical computers.

Therefore, there is a need for an approach that can effectively provide mobile device scanning of malicious programs.

### BRIEF DESCRIPTION OF THE DRAWINGS

Various exemplary embodiments are illustrated by way of example, and not by way of limitation, in the figures of the accompanying drawings in which like reference numerals refer to similar elements and in which:

FIG. 1A is a diagram of a system capable of providing mobile device scanning, according to one embodiment;

FIG. 1B is a diagram of a Third Generation Partnership Project (3GPP) Long Term Evolution (LTE) system capable of malware scanning, according to one embodiment;

FIG. 2 is a diagram of the components of a malware platform, according to an exemplary embodiment;

FIG. 3 is a flowchart of a process for providing mobile device scanning, according to an exemplary embodiment;

FIG. 4 is a flowchart of a process for initiating mobile device scanning, according to an exemplary embodiment;

FIGS. 5A and 5B are diagrams of a user interface for scanning files on a mobile device, according to various exemplary embodiments;

FIG. 6 is a diagram of an implementation of a malware platform on a computing node, according to an exemplary embodiment;

FIG. 7 is a diagram of a computer system that can be used to implement various exemplary embodiments; and

FIG. 8 is a diagram of a chip set that can be used to implement an embodiment of the invention.

### DESCRIPTION OF THE PREFERRED EMBODIMENT

An apparatus, method and software for providing mobile device scanning are described. In the following description, for the purposes of explanation, numerous specific details are set forth in order to provide a thorough understanding of the present invention. It is apparent, however, to one skilled in the art that the present invention may be practiced without these specific details or with an equivalent arrangement. In other instances, well-known structures and devices are shown in block diagram form in order to avoid unnecessarily obscuring the present invention.

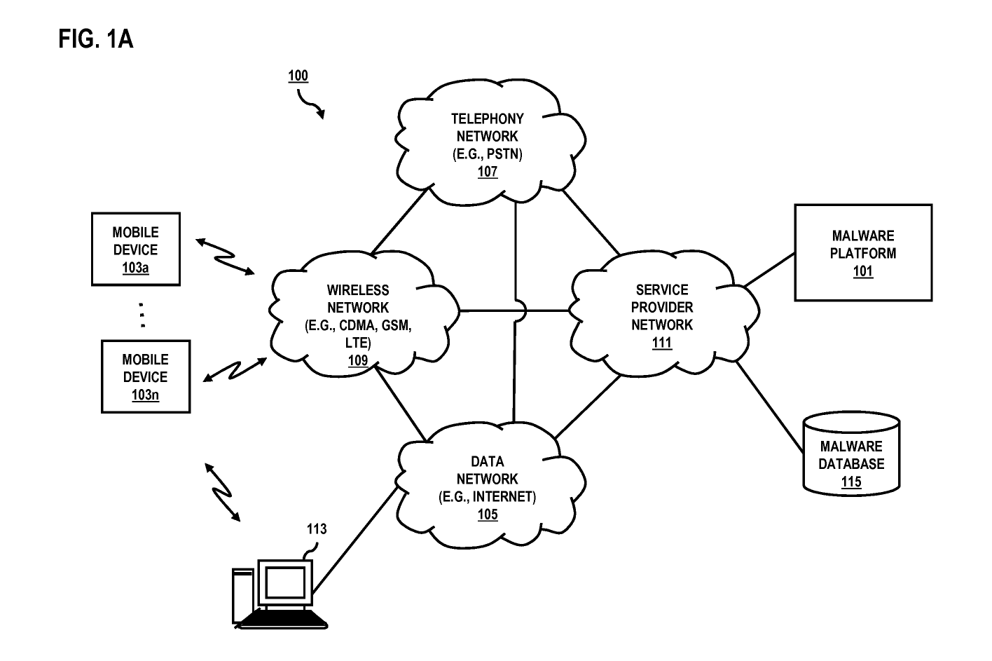

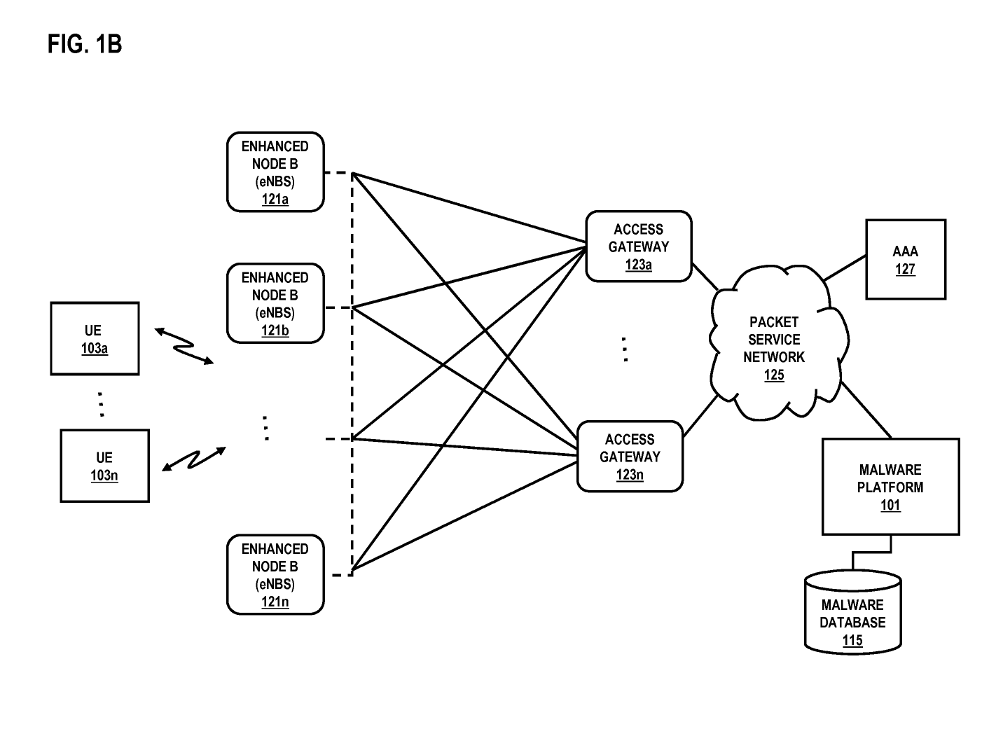

FIG. 1A is a diagram of a system capable of providing mobile device scanning, according to an exemplary embodiment. For the purpose of illustration, the system 100 including a malware platform 101 configured to provide mobile device scanning to one or more user (or client) devices (e.g., mobile devices 103) over one or more networks (e.g., data network 105, telephony network 107, wireless network 109, etc.) is described with respect to a service provider network 111. According to one embodiment, malware detection and removal services may be managed services supplied by a service provider (e.g., a wireless communication company) as a hosted or subscription-based service made available to users of the mobile devices 103 through the service provider network 111. As used herein, the term “malware” refers to malicious programs or code designed to access, without authorization. By way of example, malware may include viruses, worms, trojans, adware, spyware, etc. Thus, as shown, the malware platform 101 may be a part of or connected to the service provider network 111. According to another embodiment, the malware platform 101 may be included within or connected to a computing node (e.g., computing device 113). As such, the mobile devices 103 may be able to connect to the computing node to initiate scanning of the mobile devices 103. While specific reference will be made thereto, it is contemplated that the system 100 may embody many forms and include multiple and/or alternative components and facilities.

As mentioned, malware developers have focused their malicious software at traditional computing devices, such as servers, desktops, and notebooks, rather than mobile devices, such as smartphones, netbooks, and personal digital assistants (PDAs). Although anti-malware software may be written to run on mobile devices, mobile devices may still lack the resources required to effectively run such software. For example, because anti-malware programs may consume a substantial amount of resources (e.g., power and processing capability), such programs may cause significant latency with respect to responding to user commands or running other tasks, affecting the user experience. Thus, users may feel that the costs associated with having an anti-malware program on their mobile devices outweigh the benefits.

In certain embodiments, the malware platform 101 may include or have access to a malware database 115. For instance, the malware database 115 may contain signatures, definitions, etc., that may be used in the malware detection and removal (or extraction) process. Because malware is continually developed, to ensure that these newly developed malware are accounted for, the malware database 115 is frequently updated. The malware platform 101 may, for instance, enable users to upload new malware or variants, allowing the malware to be analyzed so that new signatures may be added to the malware database 115. Using the malware database 115, the malware platform 101 may utilize a signature-based approach, a heuristic approach, or any other approach to detect the existence or activity of malware. By way of example, the malware platform 101 may compare the contents of a file to signatures in the malware database 115. The malware platform 101 may further detect malware through a generic signature or through an inexact match to an existing signature.

Although malware developers originally targeted traditional computing devices, such as servers, desktops, and notebooks, recent technological advances for mobile devices have attracted both consumers and malware producers. Thus, as noted, mobile devices may increasing become vulnerable to all types of malware, including but not limited to viruses, worms, trojans, adware, spyware, etc. Because mobile devices are much more limited in resources than traditional computing devices, malware detection software designed for these traditional computing devices may not operate effectively or efficiently on mobile devices. For example, mobile devices may not be able to efficiently manage the processing requirements necessary to scan mobile devices for malware. Even when a particular mobile device is able to run such detection programs, the program may hinder the mobile device's ability to respond quickly to user commands and effectively run other processes or tasks. Accordingly, the user experience associated with the particular mobile device may be negatively affected. Therefore, mobile device users may be hesitant to install or run malware detection software on their mobile devices, leaving their mobile devices exposed to attack.

To address this issue, the system 100 of FIG. 1A introduces the capability to scan files from a mobile device 103 to determine the status of the file or code with regard to the presence of unauthorized code or to the execution of unauthorized activity. By way of example, the malware platform 101 may scan files associated with a manual (on-demand basis) or automatic (e.g., scheduled backup) of the mobile device 103. If the scan, for instance, indicates that the backup files has no detected malware, the malware platform 101 may notify the mobile device user (e.g., via the mobile device 103) that the mobile device is malware-free. However, if the scan indicates that there are malware-related issues associated with the backup files, the malware platform 101 may notify the mobile device user that the mobile device 103 has malware-related issues. In addition, the notification may include other information, such as the total number of files scanned, the total number of files with malware-related issues, the total number of malware-related issues resolved, the name of the files with malware-related issues, and other malware-related details.

Alternatively, the mobile device 103 may initiate the scan of the mobile device files along with or separate from file backups. The scan may, for instance, be based on a manual (or user) initiation of a backup by a user, a scheduled backup, a manual initiation of the scan by a user, a scheduled scan, an installation of an application, a detection of a low resource utilization condition (e.g., processing resources, memory storage resources, bandwidth resources, etc.), or any other event. The mobile device 103 may then transmit the files to be scanned at a computing node to determine a status (e.g., whether the files have malware-related issues). The computing node may, for instance, be configured to scan files from a multitude of mobile devices 103 including the mobile device transmitting the file. Moreover, the computing node may be a computer (e.g., server, workstation, personal computer, etc.) that is accessed via either a local link that is in near proximity to the mobile device 103 or a wireless link over a cellular network. In response, the mobile device 103 may receive a notification specifying information relating to the determined status, such as the status, statistics associated with the scan, etc. Furthermore, the malware platform 101 may request the files from the mobile device 103 to be scanned. After receiving the files stored within the mobile device 103, the malware platform 101 may initiate a scan of the files to determine status information relating to the presence of unauthorized code or to the execution of unauthorized activity. As discussed, the unauthorized code or the unauthorized activity may be related to malware. Based on the scan, the malware platform 101 may then generate a notification message specifying information relating to the determined status, such as the determined status, statistics associated with the scan, etc.

It is noted that the mobile devices 103 may be any type of mobile terminal including a mobile handset, mobile station, mobile unit, multimedia computer, multimedia tablet, communicator, netbook, Personal Digital Assistants (PDAs), smartphone, etc. It is also contemplated that the mobile devices 103 may support any type of interface for supporting the presentment or exchange of data. In addition, mobile devices 103 may facilitate various input means for receiving and generating information, including touch screen capability, keyboard and keypad data entry, voice-based input mechanisms, accelerometer (e.g., shaking the mobile device 103), and the like. Any known and future implementations of mobile devices 103 are applicable. It is noted that, in certain embodiments, the mobile devices 103 may be configured to establish peer-to-peer communication sessions with each other using a variety of technologies—i.e., near field communication (NFC), Bluetooth, infrared, etc. Also, connectivity may be provided via a wireless local area network (LAN). By way of example, a group of mobile devices 103 may be configured to a common LAN so that each device can be uniquely identified via any suitable network addressing scheme. For example, the LAN may utilize the dynamic host configuration protocol (DHCP) to dynamically assign “private” DHCP internet protocol (IP) addresses to each mobile device 103, i.e., IP addresses that are accessible to devices connected to the service provider network 111 as facilitated via a router.

In certain embodiments, the malware platform 101 may modify the scanned file based on the determined status. The malware platform 101 may then transmit the modified file to the mobile device 103, for instance, to update the file stored on the mobile device 103. Accordingly, in certain other embodiments, the mobile device 103 may receive one or more repaired files associated with the transmitted file, wherein the one or more repaired files are based on the determined status. The mobile device 103 may then update the file associated with the one or more repaired files. In one use case, the scan of the file may reveal the presence of unauthorized code or the execution of unauthorized activity, such as those related to malware, by comparing the file against a generic signature in the malware database 115. As such, the malware platform 101 may determine the file to have a status of “infected.” To resolve the issue of the “infected” file, the malware platform 101 may modify the “infected” file to eliminate or mitigate the presence of unauthorized code or the execution of unauthorized activity. After modifying the file, the malware platform 101 may instruct the mobile device 103, in the form of a notification, to prompt the mobile device user as to the existence of the “infected” file stored on the mobile device 103 and request permission to replace the “infected” file with the modified version of the file. If, for instance, permission is granted, the malware platform 101 may then transmit the modified file to replace the “infected” file on the mobile device 103.

In another scenario, the malware platform 101 may not need to explicitly permission to transmit the modified file to the mobile device 103 to update the “infected” file on the mobile device 103. For example, the malware platform 101 may already have implicit permission to transmit the modified file to the mobile device 103 based on an earlier transmission, a previous agreement, the receipt of the file from the mobile device 103, etc.

In certain embodiments, the malware platform 101 may generate a control message for transmission to the mobile device 103. The control message can include instructions for the mobile device 103 to reimage based on the status. As such, in certain other embodiments, the mobile device 103 may receive the control message. Also, the control message may include instructions to restore the mobile device 103 to its default settings (e.g., original factory) such that the data on the mobile device 103 reflects the data on the mobile device 103 prior to any modifications made by the user of the mobile device 103. The mobile device 103 may accomplish the restoration to the original factory settings, for instance, by downloading an original factory image of the mobile device 103 from the service provider, by accessing the original factory image stored on a partition of the mobile device 103, or through any other means. The control message may further include instructions to update the mobile device 103 with files and other data from a previous backup of the mobile device 103, which was determined to be free of malware-related issues. In this way, the mobile device 103 may be restored to its latest state free of malware-related issues without having to individually update “infected” files. For example, the malware platform 101 may determine that it is more effective or more efficient to reimage the mobile device 103 rather than update the each “infected” file with modified or repaired versions. Moreover, a reimaging option may be used if the malware platform 101 determines that the mobile device 103 has malware-related issues but is unable to resolve the issues by modifying files determined to be “infected” files.

In another example, an image of the mobile device 103 reflecting a previous state of the mobile device 103 may be stored, for instance, in the service provider database, on a partition of the mobile device 103, etc., wherein the previous state has been determined to be free of malware-related issues. As such, the control message may include instructions to restore the mobile device 103 to the previous state by accessing the stored image of the mobile device 103. In this way, the mobile device 103 may be able to revert back to a previous state free of malware-related issues and avoid other intermediate steps (e.g., avoiding the restoration to original factory settings).

Moreover, the mobile device 103 may be divided into one or more data sections, wherein the data sections are logically divided, physical divided, etc. A logical data section, for instance, may be divided based on virtual partitions, blocks, folders, etc. A physical division may be divided based on physical hard drives, solid-state drives (SSD), Secure Digital (SD) memory cards, random access member (RAM), etc. Based on the division, a one or more images relating to one or more data sections of a previous state of the mobile device 103 may be stored, for instance, in the service provider database, on a partition of the mobile device 103, etc., wherein the previous state has been determined to be free of malware-related issues. As such, the control message may include instructions to restore particular data sections of the mobile device 103 to the previous state by accessing the stored images, for instance, based on a determination of which data sections are associated with “infected” files. In this way, the mobile device 103 may be able to avoid losing data not included in the previous state by reverting only the particular data sections associated with “infected” files.

In some embodiments, the malware platform 101, the mobile devices 103, and other elements of the system 100 may be configured to communicate via the service provider network 111. According to certain embodiments, one or more networks, such as the data network 105, the telephony network 107, and/or the wireless network 109, may interact with the service provider network 111. The networks 105-109 may be any suitable wireline and/or wireless network, and be managed by one or more service providers. For example, the data network 105 may be any local area network (LAN), metropolitan area network (MAN), wide area network (WAN), the Internet, or any other suitable packet-switched network, such as a commercially owned, proprietary packet-switched network, such as a proprietary cable or fiber-optic network. The telephony network 107 may include a circuit-switched network, such as the public switched telephone network (PSTN), an integrated services digital network (ISDN), a private branch exchange (PBX), or other like network. Meanwhile, the wireless network 109 may employ various technologies including, for example, code division multiple access (CDMA), long term evolution (LTE), enhanced data rates for global evolution (EDGE), general packet radio service (GPRS), mobile ad hoc network (MANET), global system for mobile communications (GSM), Internet protocol multimedia subsystem (IMS), universal mobile telecommunications system (UMTS), etc., as well as any other suitable wireless medium, e.g., microwave access (WiMAX), wireless fidelity (WiFi), satellite, and the like. As described in FIG. 1B, the network 109 can be an LTE network that is configured to provide the malware scanning functions.

Although depicted as separate entities, the networks 105-109 may be completely or partially contained within one another, or may embody one or more of the aforementioned infrastructures. For instance, the service provider network 111 may embody circuit-switched and/or packet-switched networks that include facilities to provide for transport of circuit-switched and/or packet-based communications. It is further contemplated that the networks 105-109 may include components and facilities to provide for signaling and/or bearer communications between the various components or facilities of the system 100. In this manner, the networks 105-109 may embody or include portions of a signaling system 7 (SS7) network, Internet protocol multimedia subsystem (IMS), or other suitable infrastructure to support control and signaling functions.

FIG. 1B is a diagram of a Third Generation Partnership Project (3GPP) Long Term Evolution (LTE) system capable of malware scanning, according to one embodiment. Under this scenario, mobile devices 103a-103n can be denoted as user equipment (UE), which communicates with serving enhanced Node B (eNB) (i.e., base stations) 121a-121n. Each of the eNBs 121a-121n can include radio frequency transmitter(s) and receiver(s) used to communicate directly with the mobile stations 103a-103n. The eNBs 121a-121n can utilize a Multiple Input Multiple Output (MIMO) antenna systems; for instance, the eNB 121a can provide two antenna transmit and receive capabilities. This arrangement supports the parallel transmission of independent data streams to achieve high data rates. For example, on the downlink, the eNB 121a can utilize Orthogonal Frequency Division Multiplexing (OFDM), while Single Carrier Frequency Division Multiple Access (FDMA) (SC-FDMA) is used for the uplink.

Furthermore, the eNBs 121a-121n include the following components/functions: intercell Radio Resource Management (RRM); Radio Bearer (RB) Control; Radio Admission Control; Connection Mobility Control; eNB Measurement; Configuration and Provision; Dynamic Resource Allocation (Scheduler); RRC layer; RLC layer; MAC layer; and PHY layer. Additionally, the eNB can serve several cells, also called sectors, depending on the configuration and type of antenna.

As shown, the eNBs 121a-121n communicate with one or more Access Gateways (aGWs) 123a-123n according to a full mesh topology. The access gateways can establish communication links (e.g., tunnels) over a packet service network 125 (which can be an IP-based network). Among other functions, the aGWs 123a-123n can perform the following: distribution of messages to the eNBs 121a-121n, IP header compression and encryption of user data streams, termination of U-plane packets for paging reasons, and switching of U-plane for support of UE mobility. Since the aGWs 123a-123n serve as a gateway to external networks, e.g., the Internet or private consumer networks, the aGWs 123a-123n include an Access, Authorization and Accounting system 127 (AAA) to securely determine the identity and privileges of a user and to track each user's activities. According to some embodiments, the malware scanning capabilities can be provided by malware platform 101, which is accessible by the access gateways 123a-123n.

A more detailed description of the LTE interface is provided in 3GPP2 36.424, entitled “Evolved Universal Terrestrial Radio Access,” which is incorporated herein by reference in its entirety.

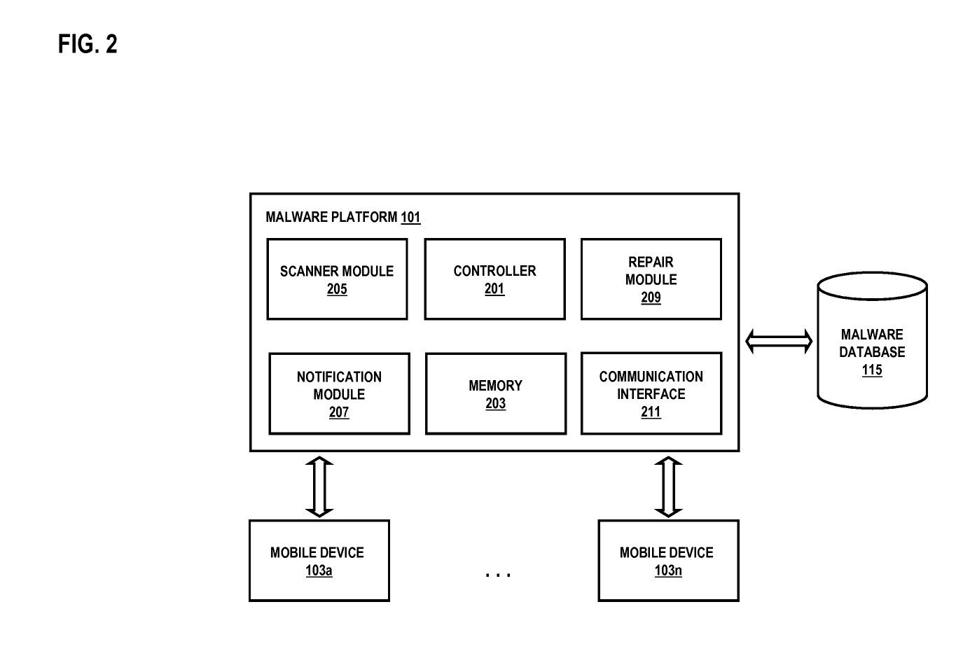

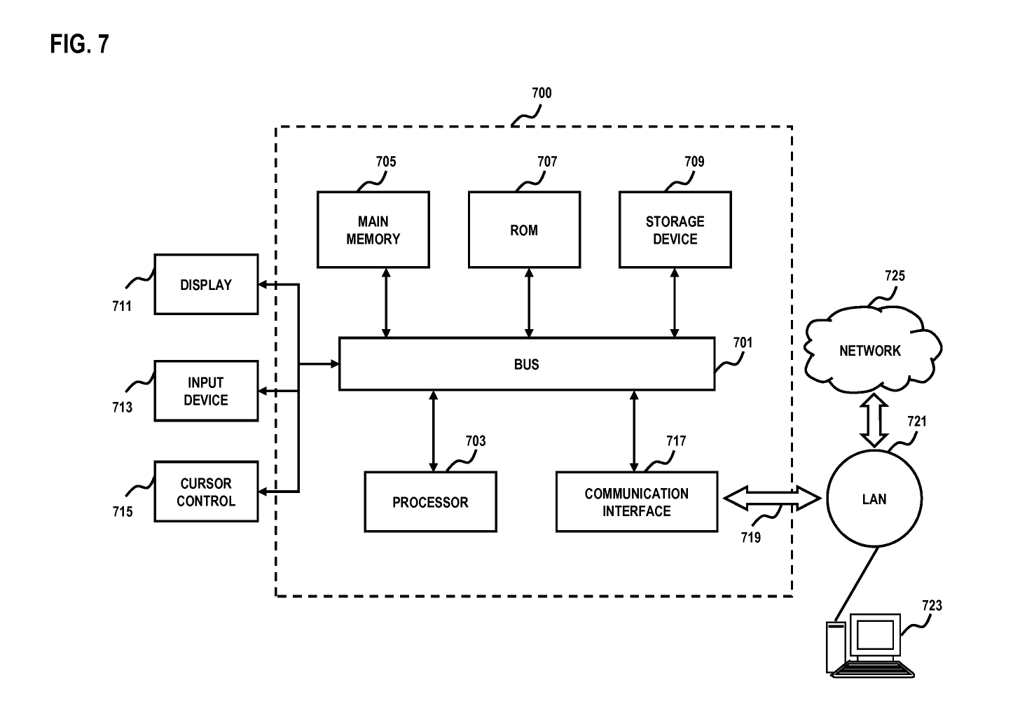

FIG. 2 is a diagram of the components of a malware platform, according to an exemplary embodiment. The malware platform 101, whether employed in the system of FIG. 1A or FIG. 1B, may comprise computing hardware (such as described with respect to FIG. 7), as well as include one or more components configured to execute the processes described herein for providing the anti-malware services of the system 100. It is contemplated that the functions of these components may be combined in one or more components or performed by other components of equivalent functionality. In one implementation, the malware platform 101 includes a controller (or processor) 201, memory 203, a scanner module 205, a notification module 207, a repair module 209, and a communication interface 211.

The controller 201 may execute at least one algorithm for executing functions of the malware platform 101. For example, the controller 201 may interact with the scanner module 205 to receive and initiate a scan of a file stored within a mobile device 103 to determine a status relating to presence of unauthorized code or to execution of unauthorized activity. As mentioned, the unauthorized code or activity may be related to malware. It is further noted that the scanner module 205 may utilize any available method (e.g., a signature-based approach, a heuristic approach, etc.) to determine such status.

Next, the controller 201 may direct the notification module 207 to generate a notification message based on the scan, wherein the notification message specifies information relating to the determined status. For example, if the scan yields a status indicating that there is no presence of unauthorized code and no execution of unauthorized activity, such as those relating to malware, the notification module 207 may transmit the notification message indicating to the user, via the mobile device 103, that the received file is malware-free.

On the other hand, if the scan returns a status indicating that unauthorized code or authorized activity is present, the notification module 207 may transmit the notification message indicating to the user that the received file contains malware. It is noted that the notification module 207 may transmit a notification message after each received file from the mobile device 103 is scanned, a combined notification message after some of the received files from the mobile device 103 are scanned, a combined notification message after all of the received files from the mobile device 103 are scanned, or a combination thereof Further, the mobile device 103 receiving the notification messages or the combined notification messages may also determine whether to display, for instance, a prompt relating to the notification messages to the mobile device user after each notification message is received, after some notification messages are received, or after all the notification messages are received.

Moreover, the controller 201 may operate in conjunction with the repair module 209 to modify scanned files based on the determined statuses of the scanned files. The controller 201 may then cause the repair module 209 to transmit the modified file to the mobile device 103 to update the file. As an example, if the determined status indicates that a scanned file is malware-free, the repair module 209 may not modify the scanned file, and thus, may also not transmit a modified file to the mobile device 103. Alternatively, the repair module 209 may modify the metadata associated with the scanned file to indicate that the scanned file is free of malware and, thereafter, transmit the modified version of the scanned file. On the other hand, if the determined status indicates that there are malware-related issues associated with the scanned file, the repair module 209 may modify the scanned file to remove or mitigate the existence of unauthorized code or activity. The repair module 209 may then transmit the modified file to the mobile device 103.

The controller 201 may also interact with the repair module to generate a control message for transmission to the mobile device 103 to instruct the mobile device 103 to reimage based on the determined statuses of the scanned files. For example, as discussed, if one or more determined statuses indicate that there are malware-related issues, the control message may instruct the mobile device 103 to reimage such that some or all of the data sections associated with the mobile device 103 are reverted to the most recent state of the mobile device 103 determined to be free of malware-related issues.

The controller 201 may further utilize the communication interface 211 to communicate with other components of the malware platform 101, the mobile devices 103, and other components of the system 100. The communication interface 211 may include multiple means of communication. For example, the communication interface 211 may be able to communicate over SMS, internet protocol, instant messaging, voice sessions (e.g., via a phone network), or other types of communication.

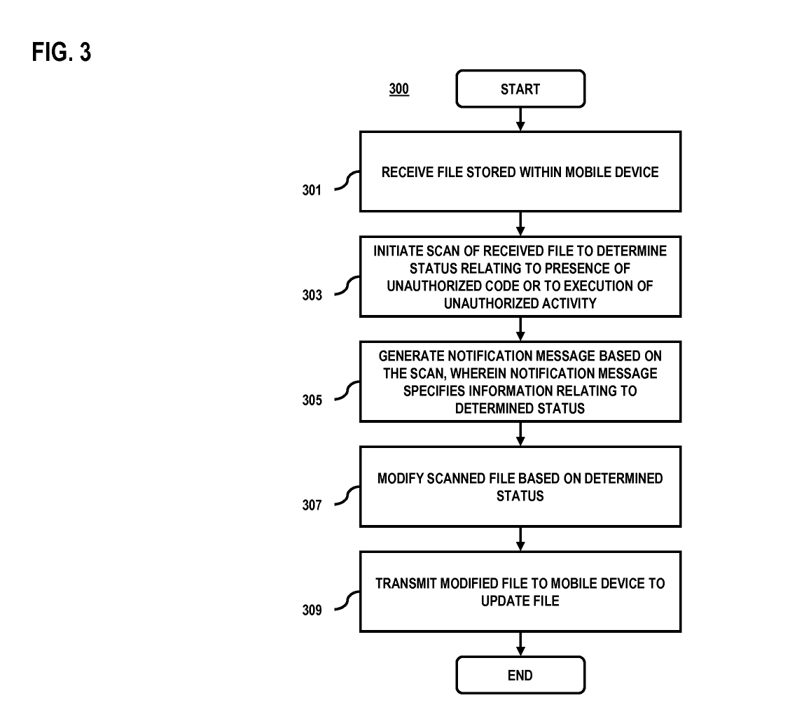

FIG. 3 is a flowchart of a process for providing mobile device scanning, according to an exemplary embodiment. For the purpose of illustration, process 300 is described with respect to FIG. 1A, notably by the malware platform 101. It is noted that the steps of the process 300 may be performed in any suitable order, as well as combined or separated in any suitable manner. In step 301, the malware platform 101 may receive a file stored within a mobile device 103. As discussed, the malware platform 101 may receive the file during a data backup of the mobile device 103. The data backup may be a manual or automatic (e.g., scheduled backup) of the mobile device 103. The malware platform 103 may also receive the file based on other events, such as a manual initiation of a scan by a user (e.g., via the mobile device 103), a scheduled scan of the mobile device 103, an installation of an application on the mobile device 103, a detection of a low resource utilization condition (e.g., processing resources, memory storage resources, bandwidth resources, etc.) of the mobile device 103, etc. Furthermore, the malware platform 101 may also request the file from the mobile device 103, for instance, if it detects the possible presence of unauthorized code or the execution of unauthorized activity on the mobile device 103.

In step 303, the malware platform 101 may initiate a scan of the received file to determine a status relating to presence of an unauthorized code or to execution of an unauthorized activity. The scan may include the utilization of a number of approaches, including a signature-based approach, a heuristic approach, or any other approach to detect the existence or activity of malware. By way of example, the malware platform 101 may detect malware-related issues by comparing the contents of the received file to signatures in the malware database 115, by comparing the contents of the received file to a generic signature in the malware database 115, by utilizing an inexact match to an existing signature, etc.

In step 305, the malware platform 101 may generate a notification message based on the scan, wherein the notification message specifies information relating to the determined status. For instance, if the scan indicates that the scanned file is malware free, the malware platform 101 may generate a notification message to be transmitted to the mobile device 103 (e.g., after each file scanned, after some files scanned, after all files scanned, etc.), indicating to the user of the mobile device 103 that the scanned file is free of malware. On the other hand, if the scan indicates that there are malware-related issues associated with the scanned file, the malware platform 101 may generate a notification message to be transmitted to the mobile device 103, indicating to the user of the mobile device 103 that the scanned file has malware-related issues. In addition, the notification message may include other information, such as the total number of files scanned, the total number of files with malware-related issues, the total number of malware-related issues resolved, the name of the files with malware-related issues, and other malware-related details.

In step 307, the malware platform 101 may modify the scanned file based on the determined status. The process 300 may then, as in step 309, determine to transmit the modified file to the mobile device 103 to update the file stored within the mobile device 103. By way of example, if the determined status indicates that the scanned file is malware-free, the malware platform 101 may not modify the scanned file, and thus, may also not transmit a modified file to the mobile device 103. However, the malware platform 101 may decide to modify the metadata associated with the scanned file to indicate that the scanned file is malware-free and transmit the modified version of the scanned file to the mobile device 103 for updating purposes. On the other hand, if the determined status indicates that there are malware-related issues associated with the scanned file, the repair module 209 may modify the scanned file to remove or mitigate the existence of unauthorized code or unauthorized activity and transmit the modified file to the mobile device 103 for updating purposes.

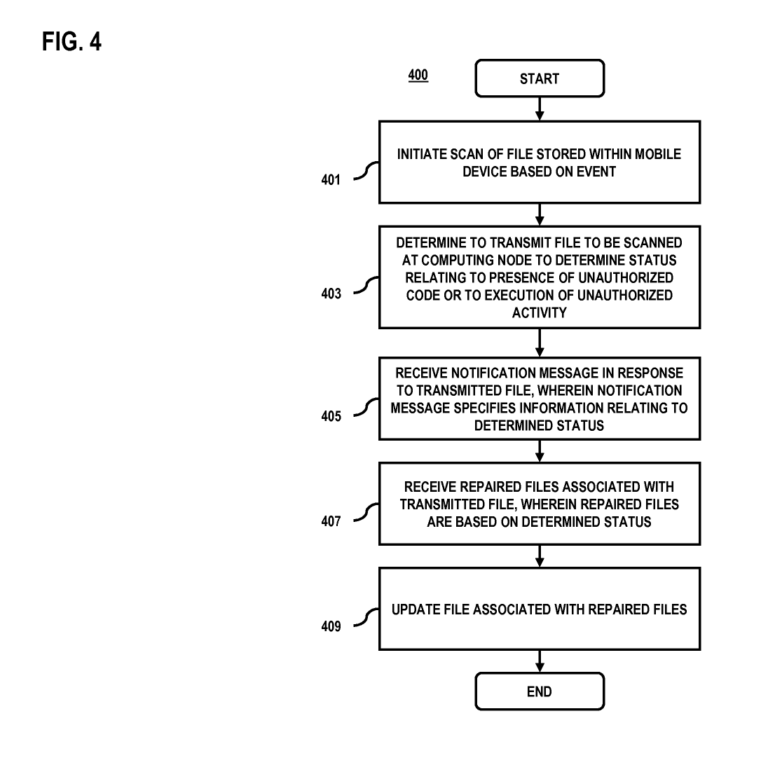

FIG. 4 is a flowchart of a process for initiating mobile device scanning, according to an exemplary embodiment. For the purpose of illustration, process 400 is described with respect to FIG. 1A. It is noted that the steps of the process 400 may be performed in any suitable order, as well as combined or separated in any suitable manner. In step 401, the process 400 (e.g., as executed by mobile device 103) may initiate a scan of a file stored within a mobile device based on an event. The scan may, for instance, be based on a manual initiation of a backup by a user, a scheduled backup, a manual initiation of the scan by a user, a scheduled scan, an installation of an application, a detection of a low resource utilization condition (e.g., processing resources, memory storage resources, bandwidth resources, etc.), or any other event.

In step 403, the mobile device 103 may determine to transmit the file to be scanned at a computing node to determine a status relating to presence of malware. The computing node may, for instance, be configured to scan files from a plurality of mobile devices 103 including the mobile device 103 transmitting the file. In addition, the computing node may be a computer (e.g., server, workstation, personal computer, etc.) that is accessed via either a local link that is in near proximity to the mobile device 103 or a wireless link over a cellular network. The mobile device 103 may also, as in step 405, receive a notification message in response to the transmitted file, wherein the notification message specifies information relating to the determined status.

In step 407, the mobile device 103 may receive one or more repaired files associated with the transmitted file, wherein the one or more repaired files are based on the determined status. As such, in step 409, the mobile device 103 may update the file associated with the one or more repaired files. By way of example, if the determined status associated with the transmitted file indicates that the transmitted file has no malware, the one or more repaired files may include metadata indicating that the transmitted file is malware free. Thus, the mobile device 103 may utilize the metadata (indicating the malware free status) to determine not to replace or alter the file associated with the one or more repaired files. In this way, the mobile device 103 may be able to avoid exhausting unnecessary resources where the file is determined to be malware free. Nonetheless, the mobile device 103 may utilize the metadata to update the metadata associated with the file to mark the file as scanned and malware free at the time of the scan. However, if the determined status associated with the transmitted file indicates that there are malware-related issues associated with the transmitted file, the one or more repaired files may be altered versions of the transmitted files without malware-related issues. As such, the mobile device 103 may replace or alter the file associated with the one or more repaired files to remove the malware-related issues of the file.

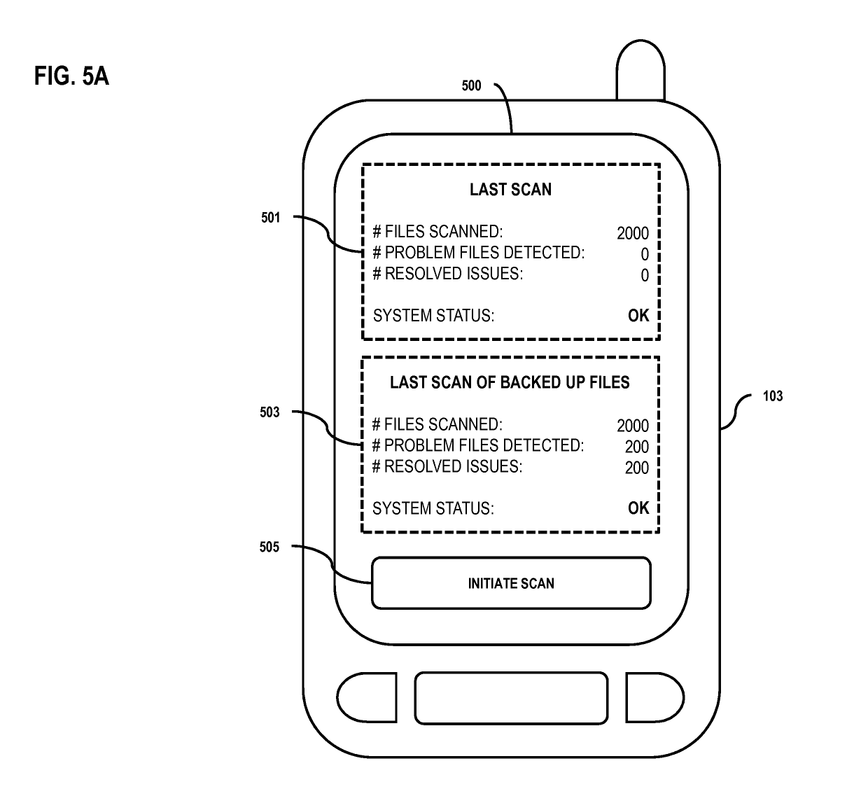

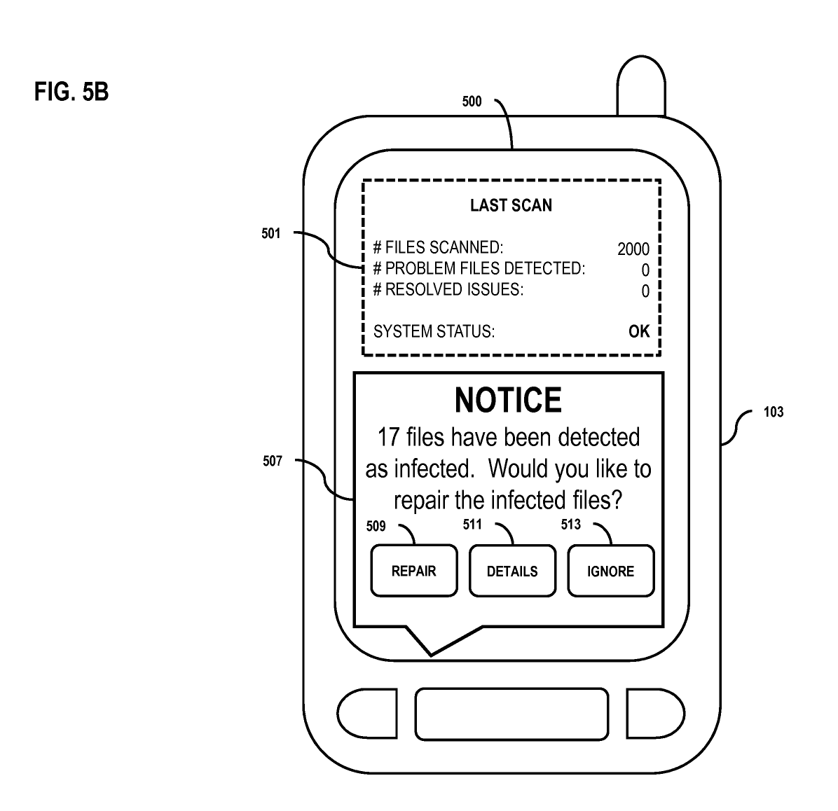

FIGS. 5A and 5B are diagrams of a user interface for scanning files on a mobile device, according to various exemplary embodiments. For illustrative purposes, the diagrams are described with reference to system 100 of FIG. 1A. For instance, FIG. 5A is a diagram of the mobile device 103 with the user interface 500 featuring histories 501 and 503, and a button 505. As mentioned, the malware platform 101 may generated notification messages based on a scan of files stored within the mobile device 103, which may also be transmitted to the mobile device 103. The histories 501 and 503 may reflect past notification messages transmitted to the mobile device 103. The history 501, for instance, provides information associated with the last scan of the mobile device files. The history 501 demonstrates that, e.g., 2000 files had been scanned, that “0” malware-related issues had been detected, that “0” malware-related issues had been resolved, and that the status of the mobile device 103 had been “OK.” The history 503 provides information associated with the last scan of files transmitted as part of a manual or scheduled backup. The history 503 demonstrates that 2000 files had been scanned, that 200 malware-related issues had been detected, that 200 malware-related issues had been resolved, and that the status of the mobile device 103 had been “OK.”. As such, the history 501 may reflect a scan initiated after the scan associated with the last manual or scheduled backup. By way of example, the user of the mobile device 103 may have initiated a scan by selecting the button 505 (e.g., “INITIATE SCAN”) sometime after a backup.

Similarly, FIG. 5B is a diagram of the mobile device 103 with the user interface 500. As seen, the user interface 500 currently features a history 501, a prompt 507, buttons 509, 511, and 513. As discussed, the history 501 provides information associated with the last scan of the mobile device files, indicating that 2000 files had been scanned, that 0 malware-related issues had been detected, that 0 malware-related issues had been resolved, and that the status of the mobile device 103 had been “OK.” In this scenario, a new scan has been initiated. The scan may have been initiated by the user of the mobile device 103 by selecting the button 505 (not shown) (e.g., “INITIATE SCAN”) or by the mobile device 103 based on some other event (e.g., backup, application installation, detection of low resource utilization, etc.). As such, a scan of the files stored within the mobile device 103 was completed and a notification message (or messages) was transmitted to the mobile device 103. As a result, the mobile device 103 provided the user with the prompt 507, stating that the scan detected 17 “infected” files. Moreover, the prompt 507 allows the user to select several options via buttons 509, 511, and 513. The mobile device user may, for instance, choose to repair the “infected” files, look at the details of the scan, or ignore the prompt 507.

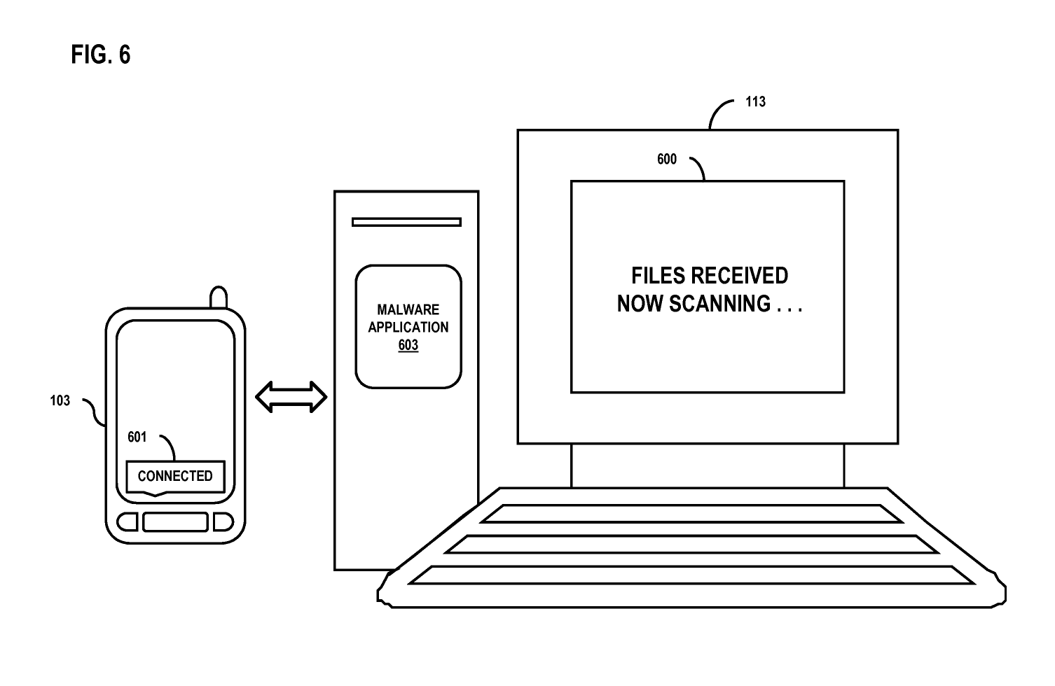

FIG. 6 is a diagram of an implementation of a malware platform on a computing node, according to an exemplary embodiment. For illustrative purposes, the diagrams are described with reference to FIG. 1A. For instance, the diagram illustrates the mobile device 103, the computing device 113 as the computing node providing the functions of the malware platform 101, a user interface 600, and a prompt 601. In one embodiment, a malware application 603 is provided to execute these functions. As discussed, the computing node may be configured to scan files from one or more mobile devices 103 (of which one is shown). In addition, the computing node may be a computer (e.g., server, workstation, personal computer, etc.) that is accessed via either a local link that is in near proximity to the mobile device 103 or a wireless link over a cellular network. Here, the computer device 113 is accessed via a local link that is near proximity to the mobile device 103. As shown, the mobile device 103 is currently connected (e.g., prompt 601) to the computing device 113, which is currently scanning (e.g., the user interface 600) the files received from the mobile device 103.

The processes described herein for providing scanning of a mobile device for malware may be implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

FIG. 7 is a diagram of a computer system that can be used to implement various exemplary embodiments. The computer system 700 includes a bus 701 or other communication mechanism for communicating information and one or more processors (of which one is shown) 703 coupled to the bus 701 for processing information. The computer system 700 also includes main memory 705, such as a random access memory (RAM) or other dynamic storage device, coupled to the bus 701 for storing information and instructions to be executed by the processor 703. Main memory 705 can also be used for storing temporary variables or other intermediate information during execution of instructions by the processor 703. The computer system 700 may further include a read only memory (ROM) 707 or other static storage device coupled to the bus 701 for storing static information and instructions for the processor 703. A storage device 709, such as a magnetic disk or optical disk, is coupled to the bus 701 for persistently storing information and instructions.

The computer system 700 may be coupled via the bus 701 to a display 711, such as a cathode ray tube (CRT), liquid crystal display, active matrix display, or plasma display, for displaying information to a computer user. An input device 713, such as a keyboard including alphanumeric and other keys, is coupled to the bus 701 for communicating information and command selections to the processor 703. Another type of user input device is a cursor control 715, such as a mouse, a trackball, or cursor direction keys, for communicating direction information and command selections to the processor 703 and for adjusting cursor movement on the display 711.

According to an embodiment of the invention, the processes described herein are performed by the computer system 700, in response to the processor 703 executing an arrangement of instructions contained in main memory 705. Such instructions can be read into main memory 705 from another computer-readable medium, such as the storage device 709. Execution of the arrangement of instructions contained in main memory 705 causes the processor 703 to perform the process steps described herein. One or more processors in a multi-processing arrangement may also be employed to execute the instructions contained in main memory 705. In alternative embodiments, hard-wired circuitry may be used in place of or in combination with software instructions to implement the embodiment of the invention. Thus, embodiments of the invention are not limited to any specific combination of hardware circuitry and software.

The computer system 700 also includes a communication interface 717 coupled to bus 701. The communication interface 717 provides a two-way data communication coupling to a network link 719 connected to a local network 721. For example, the communication interface 717 may be a digital subscriber line (DSL) card or modem, an integrated services digital network (ISDN) card, a cable modem, a telephone modem, or any other communication interface to provide a data communication connection to a corresponding type of communication line. As another example, communication interface 717 may be a local area network (LAN) card (e.g. for Ethernet™ or an Asynchronous Transfer Model (ATM) network) to provide a data communication connection to a compatible LAN. Wireless links can also be implemented. In any such implementation, communication interface 717 sends and receives electrical, electromagnetic, or optical signals that carry digital data streams representing various types of information. Further, the communication interface 717 can include peripheral interface devices, such as a Universal Serial Bus (USB) interface, a PCMCIA (Personal Computer Memory Card International Association) interface, etc. Although a single communication interface 717 is depicted in FIG. 7, multiple communication interfaces can also be employed.

The network link 719 typically provides data communication through one or more networks to other data devices. For example, the network link 719 may provide a connection through local network 721 to a host computer 723, which has connectivity to a network 725 (e.g. a wide area network (WAN) or the global packet data communication network now commonly referred to as the “Internet”) or to data equipment operated by a service provider. The local network 721 and the network 725 both use electrical, electromagnetic, or optical signals to convey information and instructions. The signals through the various networks and the signals on the network link 719 and through the communication interface 717, which communicate digital data with the computer system 700, are exemplary forms of carrier waves bearing the information and instructions.

The computer system 700 can send messages and receive data, including program code, through the network(s), the network link 719, and the communication interface 717. In the Internet example, a server (not shown) might transmit requested code belonging to an application program for implementing an embodiment of the invention through the network 725, the local network 721 and the communication interface 717. The processor 703 may execute the transmitted code while being received and/or store the code in the storage device 709, or other non-volatile storage for later execution. In this manner, the computer system 700 may obtain application code in the form of a carrier wave.

The term “computer-readable medium” as used herein refers to any medium that participates in providing instructions to the processor 703 for execution. Such a medium may take many forms, including but not limited to computer-readable storage medium ((or non-transitory)—i.e., non-volatile media and volatile media), and transmission media. Non-volatile media include, for example, optical or magnetic disks, such as the storage device 709. Volatile media include dynamic memory, such as main memory 705. Transmission media include coaxial cables, copper wire and fiber optics, including the wires that comprise the bus 701. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the embodiments of the invention may initially be borne on a magnetic disk of a remote computer. In such a scenario, the remote computer loads the instructions into main memory and sends the instructions over a telephone line using a modem. A modem of a local computer system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

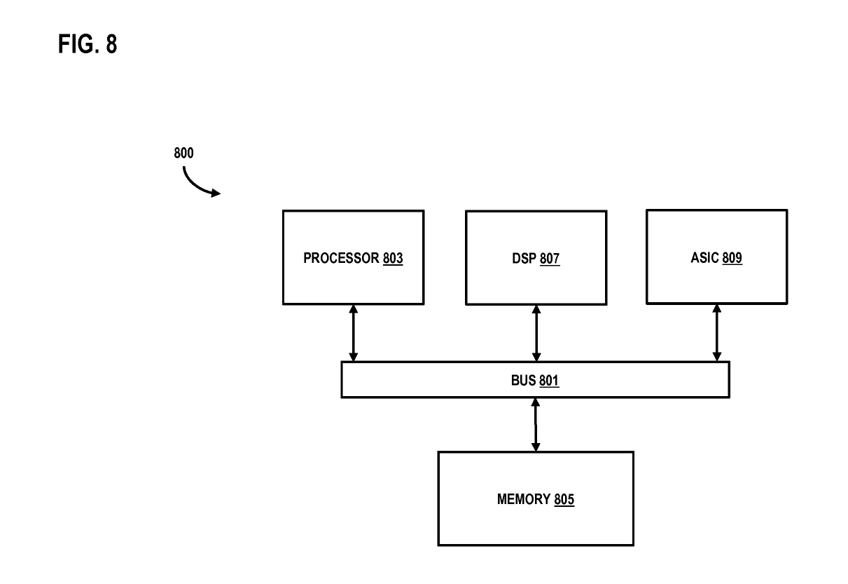

FIG. 8 illustrates a chip set or chip 800 upon which an embodiment of the invention may be implemented. Chip set 800 is programmed to enable a purchaser to immediately direct retail offers to peers within their social network based on a purchase transaction as described herein and includes, for instance, the processor and memory components described with respect to FIG. 7 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 800 can be implemented in a single chip. It is further contemplated that in certain embodiments the chip set or chip 800 can be implemented as a single “system on a chip.” It is further contemplated that in certain embodiments a separate ASIC would not be used, for example, and that all relevant functions as disclosed herein would be performed by a processor or processors. Chip set or chip 800, or a portion thereof, constitutes a means for performing one or more steps of enabling a purchaser to dynamically direct retail offers to peers within their social network based on a purchase transaction.

In one embodiment, the chip set or chip 800 includes a communication mechanism such as a bus 801 for passing information among the components of the chip set 800. A processor 803 has connectivity to the bus 801 to execute instructions and process information stored in, for example, a memory 805. The processor 803 may include one or more processing cores with each core configured to perform independently. A multi-core processor enables multiprocessing within a single physical package. Examples of a multi-core processor include two, four, eight, or greater numbers of processing cores. Alternatively or in addition, the processor 803 may include one or more microprocessors configured in tandem via the bus 801 to enable independent execution of instructions, pipelining, and multithreading. The processor 803 may also be accompanied with one or more specialized components to perform certain processing functions and tasks such as one or more digital signal processors (DSP) 807, or one or more application-specific integrated circuits (ASIC) 809. A DSP 807 typically is configured to process real-world signals (e.g., sound) in real time independently of the processor 803. Similarly, an ASIC 809 can be configured to performed specialized functions not easily performed by a more general purpose processor. Other specialized components to aid in performing the inventive functions described herein may include one or more field programmable gate arrays (FPGA) (not shown), one or more controllers (not shown), or one or more other special-purpose computer chips.

In one embodiment, the chip set or chip 800 includes merely one or more processors and some software and/or firmware supporting and/or relating to and/or for the one or more processors.

The processor 803 and accompanying components have connectivity to the memory 805 via the bus 801. The memory 805 includes both dynamic memory (e.g., RAM, magnetic disk, writable optical disk, etc.) and static memory (e.g., ROM, CD-ROM, etc.) for storing executable instructions that when executed perform the inventive steps described herein to enable a purchaser to immediately direct retail offers to peers within their social network based on a purchase transaction. The memory 805 also stores the data associated with or generated by the execution of the inventive steps.

While certain exemplary embodiments and implementations have been described herein, other embodiments and modifications will be apparent from this description. Accordingly, the invention is not limited to such embodiments, but rather to the broader scope of the presented claims and various obvious modifications and equivalent arrangements.

What is claimed is:

1. A method comprising:
receiving a file stored within a mobile device;
initiating a scan of the received file to determine a status relating to presence of an unauthorized code or to execution of an unauthorized activity; and
generating a notification message based on the scan, wherein the notification message specifies information relating to the determined status.

2. A method according to claim 1, wherein the file is received over a wireless link, the method further comprising:
modifying the scanned file based on the determined status; and
determining to transmit the modified file to the mobile device to update the file.

3. A method according to claim 2, further comprising:
generating a control message for transmission to the mobile device over the wireless link, the control message instructing the mobile device to reimage based on the determined status.

4. A method according to claim 1, wherein the unauthorized code or the unauthorized activity relates to malware.

5. An apparatus comprising:
at least one processor; and
at least one memory including computer program code for one or more programs, the at least one memory and the computer program code configured to, with the at least one processor, cause the apparatus to perform at least the following, receive a file stored within a mobile device,
initiate a scan of the received file to determine a status relating to presence of an unauthorized code or to execution of an unauthorized activity, and
generate a notification message based on the scan, wherein the notification message specifies information relating to the determined status.

6. An apparatus according to claim 5, wherein the file is received over a wireless link, and the apparatus is further caused to:
modify the scanned file based on the determined status; and
determine to transmit the modified file to the mobile device to update the file.

7. An apparatus according to claim 6, wherein the apparatus is further caused to:
generate a control message for transmission to the mobile device over the wireless link, the control message instructing the mobile device to reimage based on the determined status.

8. An apparatus according to claim 5, wherein the unauthorized code or the unauthorized activity relates to malware.

9. A method comprising:
initiating a scan of a file stored within a mobile device based on an event;
determining to transmit the file to be scanned at a computing node to determine a status relating to presence of an unauthorized code or to execution of an unauthorized activity; and
receiving a notification message in response to the transmitted file, wherein the notification message specifies information relating to the determined status.

10. A method according to claim 9, wherein the file is transmitted over a wireless link to the computing node, the method further comprising:
receiving over the wireless link one or more repaired files associated with the transmitted file, wherein the one or more repaired files are based on the determined status; and
updating the file associated with the one or more repaired files.

11. A method according to claim 9, wherein the computing node is configured to scan files from a plurality of mobile devices including the mobile device, the computing node including a computer that is accessed via either a local link that is in near proximity to the mobile device or a wireless link over a cellular network.

12. A method according to claim 9, further comprising:
receiving a control message for reimaging the mobile device based on the determined status.

13. A method according to claim 9, wherein the unauthorized code or the unauthorized activity relates to malware.

14. A method according to claim 9, wherein the event includes detection of a low resource utilization condition.

15. An apparatus comprising:
at least one processor; and
at least one memory including computer program code for one or more programs, the at least one memory and the computer program code configured to, with the at least one processor, cause the apparatus to perform at least the following,
initiate a scan of a file stored within a mobile device based on an event;
determine to transmit the file to be scanned at a computing node to determine a status relating to presence of an unauthorized code or to execution of an unauthorized activity; and
receive a notification message in response to the transmitted file, wherein the notification message specifies information relating to the determined status.

16. An apparatus according to claim 15, wherein the file is transmitted over a wireless link to the computing node and the apparatus is further caused to:
receive over the wireless link one or more repaired files associated with the transmitted file, wherein the one or more repaired files are based on the determined status; and
update the file associated with the one or more repaired files.

17. An apparatus according to claim 15, wherein the computing node is configured to scan files from a plurality of mobile devices including the mobile device, the computing node including a computer that is accessed via either a local link that is in near proximity to the mobile device or a wireless link over a cellular network.

18. An apparatus according to claim 15, wherein the apparatus is further caused to:
receive a control message for reimaging the mobile device based on the determined status.

19. An apparatus according to claim 15, wherein the unauthorized code or the unauthorized activity relates to malware.

20. An apparatus according to claim 15, wherein the event includes detection of a low resource utilization condition.
